(19) United States
(12) Patent Application Publication
(10) Pub. No.: US 2021/0313850 A1
(43) Pub. Date: Oct. 7, 2021

(54) ROTOR STRUCTURE OF PERMANENT MAGNET MOTOR

(71) Applicant: HIWIN MIKROSYSTEM CORP., Taichung City (TW)

(72) Inventors: Cheng-Hsun PAN, Taichung City (TW); Ruei-Bin HSIAO, Taichung City (TW)

(21) Appl. No.: 16/837,622

(22) Filed: Apr. 1, 2020

(51) Int. Cl. H02K 1/27; H02K 1/12; H02K 21/02

(52) U.S. Cl. CPC H02K 1/2766; H02K 21/02; H02K 1/12

(57) ABSTRACT

A rotor structure of permanent magnet motor includes a rotor and a plurality of magnetic sets arranged on the rotor. The rotor includes a body portion of a ring shape, and each one of the magnetic sets is arranged sequentially on the body portion along the ring shape of the rotor and further comprises a first permanent magnet respectively. In addition, each one of the first permanent magnets are arranged inside the body portion sequentially along the ring shape of the body portion in such a way that the magnetic flux emitted therefrom is configured to emit in a first direction toward the curvature center of the body portion.

### BACKGROUND OF THE INVENTION

### 1. Technical Field

The present invention relates to a motor, in particular, to a rotor structure of a permanent magnet motor.

### 2. Description of Related Art

In the patent application of U.S. application Ser. No. 16/700,959 previously applied by the same applicant of the present invention, it discloses the technical content that through application of the technical means of Halbach Magnetic Array to the magnet configuration of a motor rotor, the motor torque can be further increased, flux leakage can be reduced and iron loss can also be reduced. Nonetheless, the applicant seeks further improvement and continues his effort in the research to achieve the present invention. For the purpose of protecting the rights of the applicant and present invention, a patent application of the present invention is hereby disclosed and filed according to the laws.

### BRIEF SUMMARY OF THE INVENTION

A primary objective of the present invention is: to provide a rotor structure of a permanent magnet motor, capable of increasing the power density, reducing iron loss and cost. To achieve such objective, it is to arrange a plurality of first permanent magnets along a circumferential direction inside a motor rotor sequentially such that they are located at different magnetic field poles respectively. In addition, the emission direction of the magnetic flux of each of the first permanent magnets is toward the center of the motor rotor in order to guide the magnetic flux of the respective poles.

In terms of the technical content, the rotor structure of a permanent magnet motor comprises a rotor and a plurality of magnetic sets arranged on the rotor. The rotor includes a body portion of a ring shape, and each one of the magnetic sets is arranged sequentially on the body portion along the ring shape of the body portion and comprises a first permanent magnet. In addition, each one of the first permanent magnets is arranged sequentially inside the body portion along a direction of the ring shape of the body portion, such that a first direction of a magnetic flux emitted by each one of the first permanent magnets is configured to emit toward a curvature center of the body portion.

To be more specific, each one of the plurality of magnetic sets is formed by the first permanent magnet, a second permanent magnet and a third permanent magnet. In addition, for each one of the magnetic sets, the second permanent magnet and the third permanent magnet are spaced apart from each other at a predefined angle, arranged inside the body portion radially with the curvature center of the body portion as a center and disposed between the first permanent magnet of the same magnetic set and the first permanent magnet of an adjacent magnetic set. Furthermore, a second direction of a magnetic flux emitted by the second permanent magnet is configured to emit toward the third permanent magnet, and a third direction of a magnetic flux emitted by the third permanent magnet is configured to emit toward the second permanent magnet. Accordingly, each one of the magnetic sets is able to utilize the second permanent magnet and the third permanent magnet to guide the magnetic flux to emit in a direction away from the curvature center of the body portion, and following which, the first permanent magnet can be used to guide the magnetic flux to emit in a direction toward the curvature center of the body portion. Consequently, the magnetic beam can be concentrated in order to achieve the aforementioned effects of increasing the power density as well as reducing the iron loss and cost.

In addition, to control the magnetic concentration state, in each one of the magnetic sets, an angle origin between the second permanent magnet and the third permanent magnet is arranged between the same magnetic set and the curvature center of the body portion. Furthermore, the rotor structure of a permanent magnet motor can further comprise a plurality of flux barrier spaces arranged inside the body portion respectively and configured to receive proximal ends of each of the second permanent magnets and third permanent magnets adjacent to the curvature center of the body portion respectively. Moreover, in in each one of the plurality of magnetic sets, the smallest gap between the distal ends of the second permanent magnet and the third permanent magnet away from the curvature center of the body portion respectively is defined to be a first distance. In addition, at a location of the body portion of an identical radial length, the shortest distance between the second permanent magnet of one magnetic set and the third permanent magnet adjacent of another magnetic set adjacent thereto among the magnetic sets is defined to be a second distance. Furthermore, a ratio between the first distance and the second distance is between 1:1 and 1:2.

### BRIEF DESCRIPTION OF THE SEVERAL VIEWS OF THE DRAWINGS

FIG. 1 is a perspective view of a preferred embodiment of the present invention;

FIG. 2 is a front view of a preferred embodiment of the present invention;

FIG. 3 is partial plan view as viewed from the front of a preferred embodiment of the present invention;

FIG. 4 is a magnetic field line drawing of a preferred embodiment of the present invention; and

FIG. 5 is a magnetic field line drawing of the prior art.

### DETAILED DESCRIPTION OF THE INVENTION

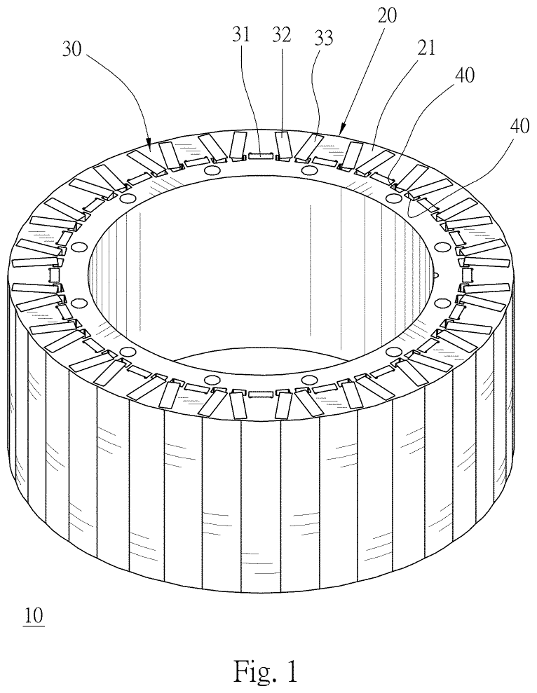

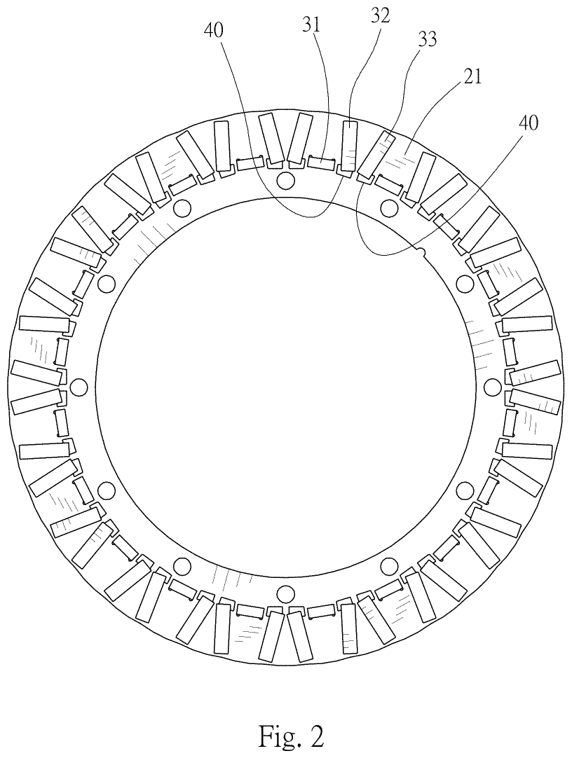

Please refer to FIG. 1 to FIG. 3, showing a rotor structure (10) of a permanent magnet motor provided according to a preferred embodiment, mainly comprising a rotor (20), a plurality of magnetic sets (30) and a plurality of flux barrier spaces (40).

The rotor (20) is a known object structure, and it is formed by a plurality of silicon steel plates stacked onto each other sequentially. In terms of the structure, it includes a body portion (21), and the body portion (21) has a circular ring shape of an appropriate axial length. In addition, the wall between the inner ring surface and the outer ring surface is provided for the arrangement of the magnetic sets (30) and the flux barrier spaces (40).

Each one of the magnetic sets (30) is embedded inside the wall of the body portion (21) sequentially along the circumference of the body portion (21) and includes a first permanent magnet (31) respectively. In addition, each one of the first permanent magnets (31) is embedded inside the wall of the body portion (21) sequentially along the circumference of the body portion (21), and a first direction (D1) of the magnetic flux emitted by each one of the first permanent magnets (31) is configured to emit toward a curvature center of the body portion (21). Accordingly, during the return process of the magnetic field, it is guided by each of the first permanent magnets (31); therefore, the power density of the motor device using such permanent magnet motor rotor structure (10) as the component element can be increased.

In addition, in this embodiment, each one of the magnetic sets (30) consist of a first permanent magnet (31), a second permanent magnet (32) and a third permanent magnet (33); wherein the second permanent magnet (32) and the third permanent magnet (33) are spaced apart from each other at an acute angle in order to be embedded inside the wall of the body portion (21), and its angle origin (C) is located between the magnetic set (30) and the body portion (21), such that the second permanent magnet (32) and the third permanent magnet (33) form a V shape and are located at one side of the first permanent magnet (31). Furthermore, the second permanent magnet (32) is disposed between the first permanent magnet (31) and the third permanent magnet (33). Moreover, in general, each one of the magnetic sets (30) having a V shape corresponding to the second permanent magnet (32) and the third permanent magnet (33) is arranged between the first permanent magnet (31) of the same magnetic set (30) and the first permanent magnet (31′) of another magnetic set (30′) adjacent thereto.

Furthermore, in terms of the shape, each one of the second permanent magnets (32) and each one of the third permanent magnets (33) are of a rectangular shape of an appropriate length in the radial direction of the body portion (21). In addition, each one of the first permanent magnets (31), in the same direction, is of a rectangular shape of a shorter length; wherein the long axis of each one of the first permanent magnet (31) is arranged perpendicular to the radial direction of the body portion (21), and the long axes of each one of the second permanent magnets (32) and each one of the third permanent magnets (33) are arranged to be at an acute angle from the radial direction of the body portion (21) respectively.

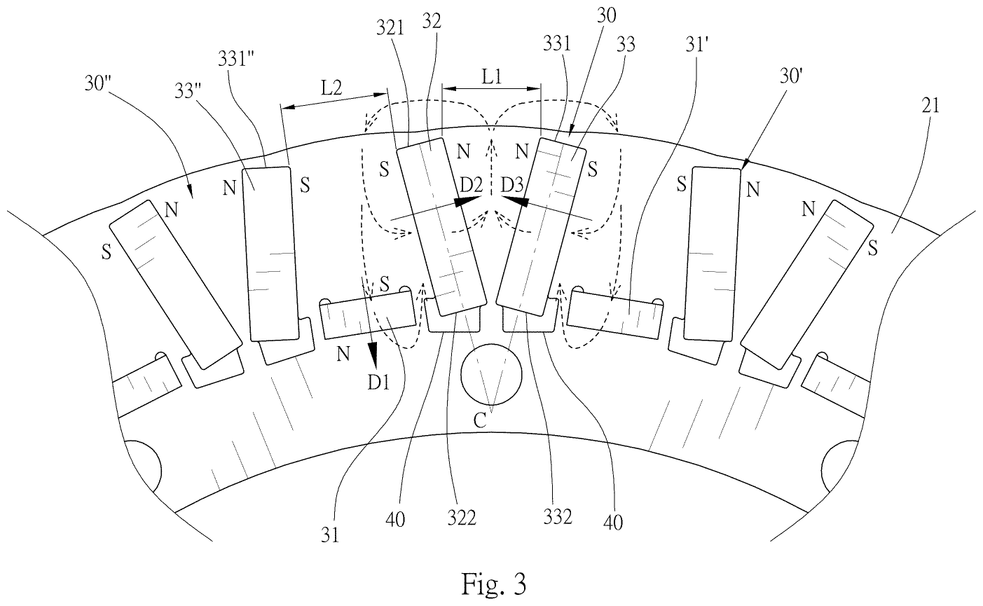

In each one of the magnetic sets (30), a second direction (D2) of a magnetic flux emitted by the second permanent magnet (32) is configured to emit toward the third permanent magnet (33), and a third direction (D3) of a magnetic flux emitted by the third permanent magnet (33) is configured to emit toward the second permanent magnet (32). Accordingly, the individual magnetic field of each one of the magnetic sets (30) can be, as shown by the dotted lines in FIG. 3, emitted between the second permanent magnet (32) and the third permanent magnet (33), and following which, it is guided by the first permanent magnet (31) and the first permanent magnet (31) of another magnetic set (30) adjacent to the third permanent magnet (33) for returning, thereby achieving a greater concentration effect for the magnetic field of each one of the magnetic sets (30).

To be more specific, in each one of the magnetic sets (30), the closest distance between the distal ends (321) (331) of the second permanent magnet (32) and the third permanent magnet (33) away from the angle origin (C) is defined to be a first distance (L1). In addition, at the location of the body portion (21) of an identical radial length, the closest distance between the distal end (321) of the second permanent magnet (32) and a distal end (331″) of the third permanent magnet (33″) of another adjacent magnetic set (30″) is defined to be a second distance (L2). Furthermore, a ratio between the first distance (L1) and the second distance (L2) is between 1:1 and 1:2, i.e. L2/L1=1˜2.

Each one of the flux barrier spaces (40) extends along the axial direction of the body portion (21) and penetrates into the through hole on the wall of the body portion (21). In addition, the flux barrier spaces (40) in pair are disposed between the adjacent first permanent magnets (31). Furthermore, the proximal ends (322) (332) adjacent to the origin (C) of each one of the second permanent magnets (32) and each one of the third permanent magnets (33) are inserted into the corresponding flux barrier spaces (40) respectively.

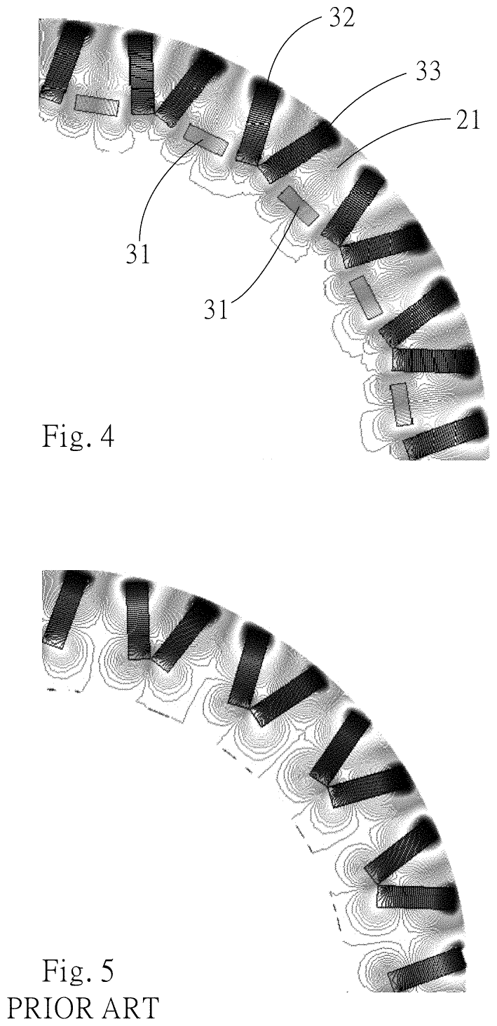

With the assembly of the aforementioned components, in one aspect, the rotor structure (10) of a permanent magnet motor is able to utilize each one of the second permanent magnets (32) and each one of the third permanent magnets (33) to concentrate the magnetic flux for emitting outward; and in another aspect, each one of the first permanent magnets (31) is able to guide magnetic flux for returning, thereby achieving a greater concentration effect for the magnetic field of each one of the magnetic sets (30). From the comparison between the magnetic field line drawing of this embodiment shown in FIG. 4 and the magnetic field line drawing of the prior art shown in FIG. 5, it is evident that the present invention is able to achieve the ultimate effect of improving the motor power.

What is claimed is:

1. A rotor structure of a permanent magnet motor, comprising:
a rotor having a body portion of a ring shape;
a plurality of magnetic sets arranged sequentially on the body portion along the ring shape of the body portion;
characterized in that:
each one of the plurality of magnetic sets comprises a first permanent magnet arranged sequentially along a direction of the ring shape of the body portion, and a first direction of a magnetic flux emitted by the first permanent magnet is configured to emit toward a curvature center of the body portion.

2. The rotor structure of a permanent magnet motor according to claim 1, wherein each one of the plurality of magnetic sets consist of the first permanent magnet, a second permanent magnet and a third permanent magnet; the second permanent magnet and the third permanent magnet of each one of the plurality of magnetic sets are spaced apart from each other at a predefined angle, arranged inside the body portion radially with the curvature center of the body portion as a center and disposed between the first permanent magnet of the same magnetic set and the first permanent magnet of an adjacent magnetic set; and a second direction of a magnetic flux emitted by the second permanent magnet is configured to emit toward the third permanent magnet, and a third direction of a magnetic flux emitted by the third permanent magnet is configured to emit toward the second permanent magnet.

3. The rotor structure of a permanent magnet motor according to claim 2, wherein an angle origin between the second permanent magnet and the third permanent magnet of each one of the plurality of magnetic sets is arranged closer to the curvature center than the second permanent magnet and the third permanent magnet.

4. The rotor structure of a permanent magnet motor according to claim 3, wherein, in each one of the plurality of magnetic sets, the second permanent magnet is disposed between the third permanent magnet and the first permanent magnet, and a first distance of a closest distance between distal ends of the second permanent magnet and the third permanent magnet away from the curvature center of the body portion respectively is smaller than or equivalent to a second distance of a closest distance between the second permanent magnet at a location of the body portion of an identical radial length and the third permanent magnet of an adjacent magnetic set.

5. The rotor structure of a permanent magnet motor according to claim 4, wherein a ratio between the first distance and the second distance is between 1:1 and 1:2.

6. The rotor structure of a permanent magnet motor according to claim 1, wherein each one of the first permanent magnets is of a rectangular shape at a radial direction of the body portion, and a long axis thereof is arranged perpendicular to the radial direction of the body portion.

7. The rotor structure of a permanent magnet motor according to claim 2, wherein each one of the first permanent magnets is of a rectangular shape at a radial direction of the body portion, and a long axis thereof is arranged perpendicular to the radial direction of the body portion.

8. The rotor structure of a permanent magnet motor according to claim 2, wherein each one of the second permanent magnets is of a rectangular shape on a radial direction of the body portion, and a long axis thereof is arranged to be at an acute angle from the radial direction of the body portion.

9. The rotor structure of a permanent magnet motor according to claim 2, wherein each one of the third permanent magnets is of a rectangular shape at a radial direction of the body portion, and a long axis thereof is arranged to be at an acute angle from the radial direction of the body portion.

10. The rotor structure of a permanent magnet motor according to claim 2, further comprising a plurality of flux barrier spaces arranged inside the body portion respectively and configured to receive proximal ends of each of the second permanent magnets and the third permanent magnets adjacent to the angle origin therebetween respectively.

11. The rotor structure of a permanent magnet motor according to claim 10, wherein each of the plurality of flux barrier spaces is arranged along a direction of the ring shape of the body portion and is disposed between the first magnets adjacent to each other.
